(19) United States
(12) Patent Application Publication
(10) Pub. No.: US 2016/0257246 A1
(43) Pub. Date: Sep. 8, 2016

(54) Illumination Device

(71) Applicant: Tsujii Kogyo Kabushiki Kaisha, Kawanishi-shi (JP)

(72) Inventor: Kisaburo Tsujii, Kawanishi-shi (JP)

(21) Appl. No.: 14/959,314

(22) Filed: Dec. 4, 2015

(30) Foreign Application Priority Data
Mar. 3, 2015 (JP) 2015-000987

(51) Int. Cl. B60Q 1/56; F21S 8/10

(52) U.S. Cl. CPC B60Q 1/56; F21S 48/2225; F21S 48/2281; F21Y 2101/02

(57) ABSTRACT

An illumination device which can contribute to traffic safety is provided.

An illumination device according to the present invention illuminating a license number plate of a vehicle comprises a first light source with an optical axis directed to a display surface of the number plate, a second light source with an optical axis extending along the display surface, and a support member arranged around the number plate to support the first light source and the second light source.

### CROSS-REFERENCE TO RELATED APPLICATIONS

This non-provisional application claims priority under 35 U.S.C. §119(a) on Utility Model Application No. 2015-987 filed in Japan on Mar. 3, 2015, the entire contents of which are hereby incorporated by reference.

### FIELD

The present invention relates to an illumination device illuminating a license number plate of a vehicle.

### BACKGROUND

Conventionally, a decorative member which decorates a license number plate (hereinafter referred to as NP) of a vehicle has been proposed (Japanese Utility Model Registration No. 3176993, which is hereinafter referred to as Patent Document 1).

A decorative member described in Patent Document 1 comprises a reflection part arranged around an NP. The reflection part reflects light emitted from a light source outside the decorative member (e.g., headlight of another vehicle), which enhances the decorative effect of an NP.

### SUMMARY

If the visibility of an NP is enhanced, it is easier for a pedestrian or a driver of another vehicle to recognize the presence of a vehicle. This, therefore, improves safety and suppresses the occurrence of a traffic accident.

However, in the case of the decorative member described in Patent Document 1, for example, when the surrounding area is too bright or when light from the outside does not properly enter the reflection part, it is more difficult for the reflection part to stand out compared to when the surrounding area is appropriately dark and light from the outside properly enters the reflection part. Therefore, the decorative member described in Patent Document 1 is deficient to enhance the visibility of an NP.

The present invention has been made in view of the circumstances described above, and mainly aims to provide an illumination device which may contribute to traffic safety.

An illumination device according to the present invention illuminating a license number plate of a vehicle comprises a first light source with an optical axis directed to a display surface of the number plate, a second light source with an optical axis extending along the display surface, and a support member arranged around the number plate to support the first light source and the second light source.

In the illumination device according to the present invention, each of the first light source and the second light source has a plurality of LEDs arranged side by side in a circumferential direction of the number plate, the LED is configured to be supplied with power from the vehicle, and the support member includes a first support part supporting the first light source such that an optical axis of each LED included in the first light source is directed to the display surface, and a second support part supporting the second light source such that an optical axis of each LED included in the second light source extends along the display surface.

In the illumination device according to the present invention, the first support part has a shape of a frame arranged to be opposed to a circumferential part of the display surface, the second support part has a tubular shape surrounding a circumferential part of the number plate, the first light source is arranged in an annular pattern on the side of the display surface of the first support part, and the second light source is arranged in an annular pattern on an inner circumferential surface of the second support part.

In the illumination device according to the present invention further comprises a light guide member for guiding light emitted from the first light source or the second light source toward the display surface. The light guide member is arranged in an annular pattern closer to an inner circumferential part of the first support part than the first light source on the side of the display surface of the first support part.

The illumination device according to the present invention further comprises a light reflection member or a light guide member arranged on the support member to guide light emitted from the first light source or the second light source toward the display surface.

According to the present invention, since an NP is illuminated, the visibility of the NP is improved compared to the case where the decorative member described in Patent Document 1 is used. Moreover, as the first light source and the second light source illuminate the NP from two different directions, the visibility of the NP is improved compared to the case where one of the first light source and the second light source illuminates the NP. Furthermore, since the light illuminated the NP from two different directions is reflected at the NP and diffused in different directions, the visibility of the NP for a wider range around a vehicle is improved.

As a result, it is easy for a pedestrian or a driver of another vehicle to recognize the presence of a vehicle.

According to the present invention, as a plurality of LEDs are arranged side by side in two rows in the circumferential direction of an NP, the number of LEDs may easily be increased compared to the case where a plurality of LEDs are arranged side by side in one row in the circumferential direction of an NP. Accordingly, an NP may be illuminated to be sufficiently bright. Therefore, the visibility of the NP is sufficiently improved.

Since the LED is supplied with power from a vehicle, it is unnecessary for an illumination device to include a separate power supply. This allows for a compact structure of the illumination device.

According to the present invention, as LEDs in two rows are arranged side by side along the entire circumference of an NP, the NP may very brightly be illuminated. Therefore, the visibility of the NP is significantly improved.

According to the present invention, as the light emitted from the first light source or the second light source is guided by the light guide member or the light reflection member to efficiently illuminate the NP, the visibility of the NP is further improved.

In the case of the illumination device according to the present invention, since the NP is illuminated from two different directions, the visibility of the NP for a wider range around a vehicle may be improved. Therefore, a pedestrian or a driver of another vehicle may easily recognize the presence of the vehicle. As a result, the present invention produces beneficial effects that may contribute to traffic safety, may suppress the occurrence of a traffic accident, and so forth.

The above and further objects and features of the invention will more fully be apparent from the following detailed description with accompanying drawings.

### BRIEF DESCRIPTION OF THE DRAWINGS

FIG. 1 is a front view schematically illustrating a structure of an illumination device according to Embodiment 1 of the present invention;

FIG. 2 is a section view schematically illustrating a structure of an illumination device; and

FIG. 3 is a section view schematically illustrating a structure of an illumination device according to Embodiment 2 of the present invention.

### DETAILED DESCRIPTION

The present invention will be described in detail below with reference to the drawings illustrating the embodiments thereof. In the description below, up-down, front-back and left-right directions indicated by arrows in the drawings are used.

### Embodiment 1

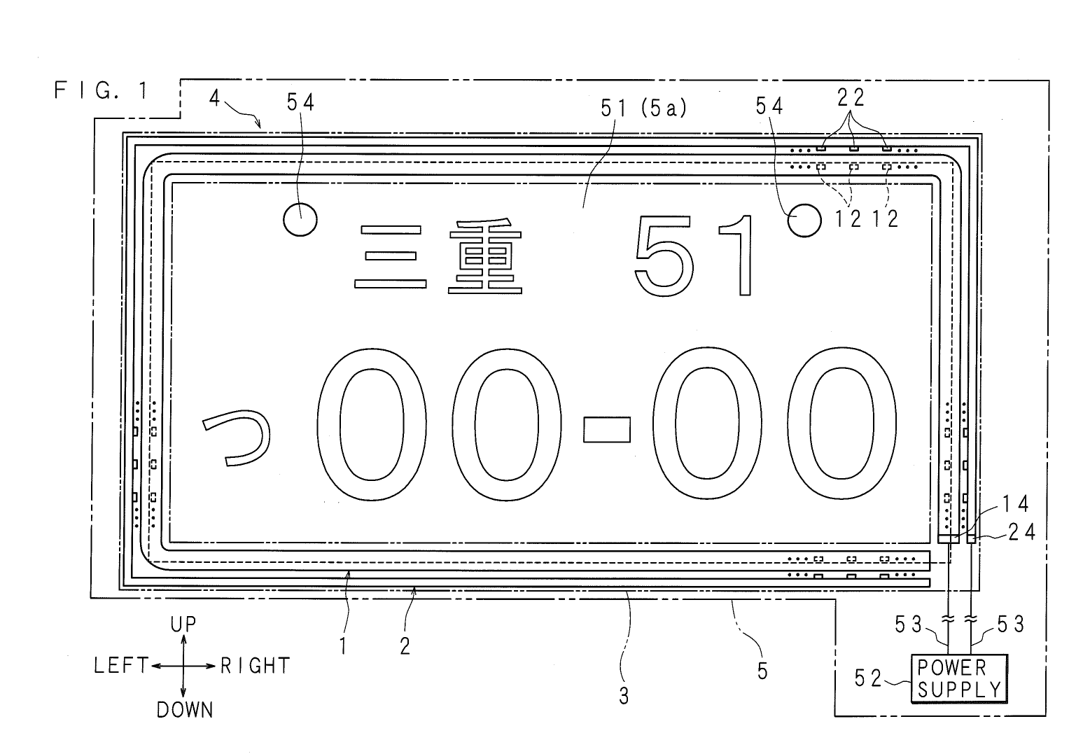

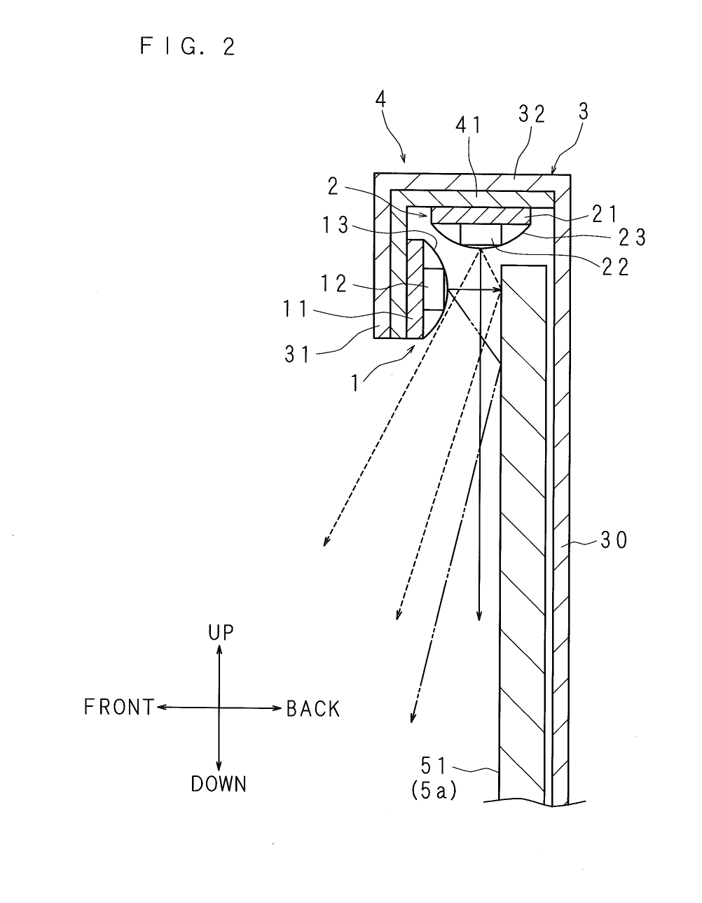

FIGS. 1 and 2 are a front view and a section view, respectively, schematically illustrating the structure of an illumination device 4 according to Embodiment 1 of the present invention.

The illumination device 4 according to the present embodiment is attached to a vehicle 5 together with an NP 51. A power supply 52 is mounted to the vehicle 5. The power supply 52 is a battery, an electric generator or the like. Hereinafter, an NP 51 having a general rectangular shape is illustrated, though not limited thereto.

First, each component of the illumination device 4 is described.

The illumination device 4 comprises a first light source 1, a second light source 2, a support member 3 and a light reflection member 41.

The first light source 1 is constituted by using a so-called tape LED. The first light source 1 includes an LED substrate 11, multiple LEDs 12, 12 . . . , a waterproof part 13 and a connector 14.

The LED substrate 11 has a band-like shape having flexibility.

The LEDs 12, 12, . . . are arranged side by side separated with an appropriate distance from one another in the length direction of the LED substrate 11, and are mounted on one surface side of the LED substrate 11.

The waterproof part 13 covers the LED substrate 11 and LEDs 12, 12 . . . to make them watertight. At least a part of the waterproof part 13 has translucency. The light emitted from each LED 12 passes through a translucent portion of the waterproof part 13, and is output to the outside of the first light source 1. In FIG. 1, the waterproof part 13 is not illustrated.

The connector 14 is located at one end of the LED substrate 11, and is electrically connected to the power supply 52 through a cable 53. The electric power from the power supply 52 is supplied to each LED 12 through the cable 53 and connector 14.

The second light source 2 includes an LED substrate 21, LEDs 22, 22 . . . , a waterproof part 23 and a connector 24. These components correspond to the LED substrate 11, LEDs 12, 12 . . . , waterproof part 13 and connector 14 in the first light source 1. In FIG. 1, the waterproof part 23 is not illustrated. The structure of the second light source 2 is similar to that of the first light source 1, and thus will not be described.

The support member 3 is made of synthetic resin or metal. The support member 3 includes a support base 30, a first support part 31 and a second support part 32.

The support base 30 has the shape of a flat plate larger than the NP 51. More specifically, the support base 30 has the shape of a rectangular flat plate having the respective dimensions of the upper, lower, left and right directions longer than those of the NP 51. The support base 30 is fastened to the vehicle 5 together with the NP 51 using two bolts 54, 54, in the state where the circumferential part of the support base 30 is arranged around the NP 51. Here, the support base 30 and the NP 51 are arranged in a vertical posture. The support base 30 is provided with through holes (not illustrated) through which the cables 53, 53 are inserted. Passing the through holes, the cables 53, 53 connect the connectors 14, 24 with the power supply 52.

The first support part 31 has a frame-like shape. More specifically, the first support part 31 has a rectangular frame-like shape, and a flat-plate shape in the vertical posture arranged to be opposed to the circumferential part of the front face of the support base 30. The dimensions in the upper, lower, left and right directions concerning the outer circumferential part of the first support part 31 are equal to the respective dimensions in the upper, lower, left and right directions of the support base 30.

The first support part 31 supports the first light source 1. The first light source 1 is arranged at a rear face of the first support part 31 in a rectangular and annular pattern, with the other surface side of the LED substrate 11 facing the first support part 31. Here, the length direction of the LED substrate 11 of the first light source 1 corresponds to the circumferential direction of the first support part 31.

The second support part 32 has a tubular shape. More specifically, the second support part 32 has the shape of a rectangular tube in the lateral posture, the axial direction being the front-back direction. The dimensions of the upper, lower, left and right directions of the second support part 32 are equal to the upper, lower, left and right directions of the support base 30. The second support part 32 connects the first support part 31 with the support base 30. Thus, the front end of the second support part 32 is connected to the outer circumferential part of the first support part 31, and the rear end of the second support part 32 is connected to the circumferential part of the support base 30.

The second support part 32 supports the second light source 2. The second light source 2 is arranged in the rectangular and annular pattern on the inner surface of the second support part 32, with the other face side of the LED substrate 21 facing the second support part 32. Here, the length direction of the LED substrate 21 of the second light source 2 corresponds to the circumferential direction of the second support part 32.

The light reflection member 41 covers the rear face of the first support part 31 and the inner face of the second support part 32. In the present embodiment, a light reflection tape is used as the light reflection member 41. Moreover, in the present embodiment, the light reflection member 41 is interposed between the first light source 1 and the first support part 31, and also between the second light source 2 and the second support part 32. The light reflection member 41 may, however, also cover the rear face of the first support part 31 and the inner face of the second support part 32 while avoiding the first light source 1 and the second light source 2.

It is to be noted that the support member 3 may also serve as the light reflection member 41. In this case, the support member 3 is either formed with a material having light reflectivity, or a light reflection film is formed on the rear face of the first support part 31 and the inner face of the second support part 32.

Next, the positional relationship between the illumination device 4 and the NP 51 is described.

The support base 30 is attached to the vehicle 5 together with the NP 51, the first support part 31 and the second support part 32 are arranged around the NP 51. In other words, each of the first support part 31 and the second support part 32 has a frame-like shape surrounding the NP 51.

Here, the rear face of the first support part 31 is arranged to be opposed to the circumferential part of the display surface 5a of the NP 51. As a result, the optical axis of each LED 12 in the first light source 1 extends toward (orthogonal to, for example) the circumferential part of the display surface 5a of the NP 51. Moreover, the LEDs 12, 12 . . . are arranged in the circumferential direction of the NP 51.

On the other hand, the second support part 32 surrounds the circumferential part of the NP 51. As a result, the optical axis of each LED 22 in the second light source 2 extends along (e.g., is in parallel with) the display surface 5a of the NP 51. Moreover, the LEDs 22, 22 . . . are arranged in the circumferential direction of the NP 51.

In FIG. 2, the respective optical axes of the LEDs 12 and 22 are indicated by solid arrows.

The dimensions in the upper, lower, left and right directions concerning the inner circumferential part of the first support part 31 are short enough to locate each LED 12 of the first light source 1 to be opposed to the circumferential part of the display surface 5a of the NP 51, and are long enough to prevent the first support part 31 from hiding the indications shown on the NP 51.

Note that the front face of the first support part 31 is located more front (the side opposite to the vehicle 5 side) than the NP 51. Therefore, the front face of the first support part 31 may be provided with a decoration.

Next, functions and effects of the illumination device 4 are described.

Each of the LEDs 12, 12 . . . and LEDs 22, 22 . . . is supplied with power from the power supply 52 of the vehicle 5 to emit light. The illumination device 4 is compact, since it does not include a power supply.

The light emitted by the LEDs 12 and 22 radiate around the directions of the respective optical axes. In FIG. 2, a part of the light emitted from the first light source 1 is indicated by a dashed-two dotted arrow, while a part of the light emitted from the second light source 2 is indicated by a dashed arrow.

A part of the light emitted from the first light source 1 and the second light source 2 enters the display surface 5a of the NP 51 directly or after being reflected by the light reflection member 41. That is, the display surface 5a is illuminated. Therefore, compared to the case where the display surface 5a is not illuminated, the visibility of the display surface 5a is improved. The improvement in visibility of the display surface 5a contributes to the enhancement of legibility, readability and decipherability of the indications shown on the display surface 5a.

The illuminated display surface 5a is brighter than the case where one of the first light source 1 and the second light source 2 illuminates the display surface 5a, and thus is highly visible. This is because it has twice as many LEDs illuminating the display surface 5a. There is a limitation in the number of LEDs that can be arranged side by side in one of the first light source 1 and the second light source 2. It is thus advantageous to include both the first light source 1 and the second light source 2, also from the viewpoint of enhancement in brightness due to the increased number of LEDs. Moreover, the illuminated display surface 5a is brighter than the case where no light reflection member 41 is present, and thus is highly visible. This is because the light emitted from the first light source 1 or the second light source 2 effectively illuminates the NP 51.

A part of the light entered the display surface 5a of the NP 51 is reflected to the front face side of the NP 51. Furthermore, another part of the light emitted from each LED 22 is output to the front face side of the NP 51 without entering the display surface 5a of the NP 51. Such light thus output to the front face side of the NP 51 illuminates a wider range at the front face side of the NP 51 brighter compared to the case where one of the first light source 1 and the second light source 2 illuminates the display surface 5a. The reason for this is that, as the first light source 1 and the second light source 2 illuminate the NP 51 from two different directions, the light reflected at the NP 51 is diffused in different directions. Moreover, since the first light source 1 and the second light source 2 are arranged over the entire circumference of the NP 51, the number of LEDs are larger than the case where the LEDs are arranged at a part (e.g., only the upper side of the NP 51) in the circumferential direction of the NP 51, and the light reflected at the NP 51 is diffused to a wider range.

This means that the visibility of the NP 51 with respect to a wider range of the front face side of the NP 51 is improved. That is, the NP 51 easily stands out.

As a result, the vehicle 5 to which the illumination device 4 is attached together with the NP 51 has such an advantage that a pedestrian or a driver of another vehicle may easily recognize the presence of the vehicle 5 even under a condition of low visibility such as inside a tunnel or in the nighttime, or under adverse weather conditions such as heavy rain, blizzard or the like. This can therefore contribute to traffic safety and suppress the occurrence of a traffic accident. Such an illumination device 4 may be suitable, not only to a general vehicle (private automobile, company automobile or the like), but also to a highly public vehicle (official vehicle, emergency automobile or the like) in particular.

The illumination device 4 has such a structure that the light reflected at the NP 51 is projected to the front face side of the NP 51, which may avoid such a risk that a pedestrian or a driver of another vehicle are dazzled by excessively intense light, compared to the structure where the light emitted from the light source is directly projected to the front face side of the NP 51.

It is to be noted that the illumination device 4 may also have, not limited to the structure of being attached to the vehicle 5 together with the NP 51, a structure of being directly attached to the NP 51 itself or being attached to the vehicle 5 separately from the NP 51. Furthermore, the illumination device 4 may also be attached with the use of, for example, a clamp, an adhesive material or the like, not limited to the use of bolts 54, 54.

The structure of each of the first light source 1 and the second light source 2 is not limited to the description in the present embodiment. For example, a light emitting component other than LEDs may alternatively be used. The structure of the support member 3 is not limited to the one described in the present embodiment. For example, the support base 30 may also have a frame-like shape similar to the first support part 31, and the support member 3 may have the shape of a bar (or two bars) corresponding to one side (or two sides) of the NP 51. The light reflection member 41 may be eliminated. The illumination device 4 may also be provided with a power supply.

The light emitted from the first light source 1 and the second light source 2 pass through the waterproof parts 13, 23 and thus are more diffused than the case without the waterproof parts 13, 23. It is thus easier to uniformly illuminate the display surface 5a. The indication shown on the uniformly-illuminated display surface 5a may easily be read compared to the case where the illumination is not uniform. In order to further enhance the uniformity of illumination, the illumination device 4 may additionally be provided with a light diffusion member. As long as the first light source 1 and the second light source 2 may be made watertight by anything other than the waterproof parts 13, 23, the first light source 1 and the second light source 2 may have a structure without the waterproof parts 13, 23.

### Embodiment 2

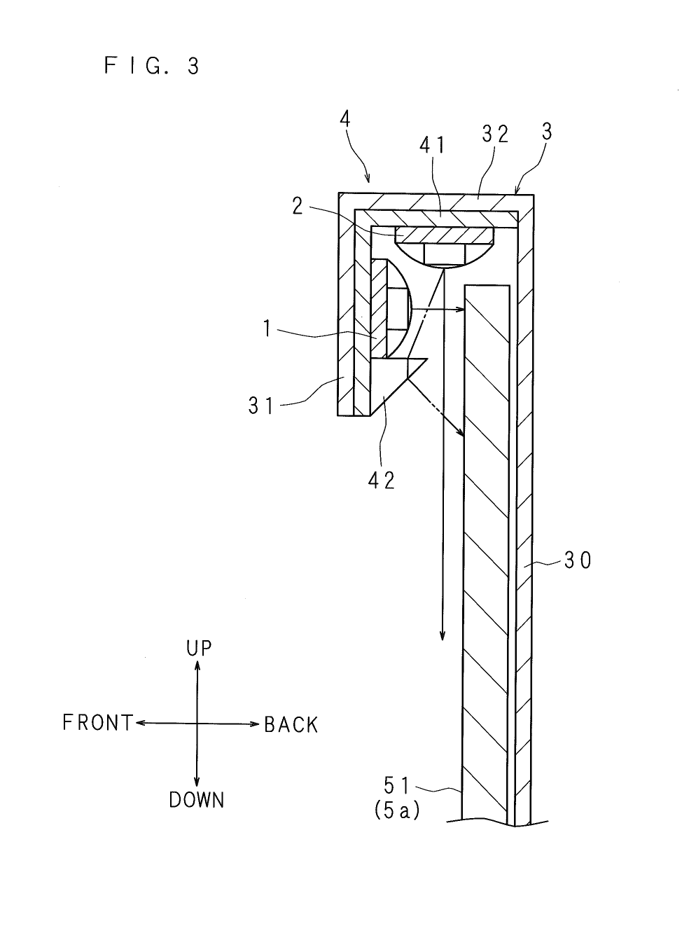

FIG. 3 is a section view schematically illustrating a structure of an illumination device 4 according to Embodiment 2 of the present invention. FIG. 3 corresponds to FIG. 2 in Embodiment 1.

The illumination device 4 according to the present embodiment has a structure substantially similar to that of the illumination device 4 according to Embodiment 1. In the following, the difference between the present embodiment and Embodiment 1 will be described, while the parts corresponding to those in Embodiment 1 will be denoted by the same reference numerals and will not be described.

The illumination device 4 further includes a light guide member 42.

The light guide member 42 is supported by a support member 3. The light emitted from the first light source 1 or the second light source 2 is reflected at the surface of a light reflection member 41 or a light guide member 42, or is refracted when passing through the inside of the light guide member 42, to be guided toward a display surface 5a. As a result, compared to the case where the light reflection member 41 and the light guide member 42 are not present, the display surface 5a is more brightly illuminated.

The light guide member 42 according to the present embodiment has four bar-like members made of acrylic resin. The light guide member 42 is arranged in a rectangular and annular pattern along the inner circumferential part of the rear face of the first support part 31. The first light source 1 is arranged closer to the outer circumferential part than the light guide member 42.

The light guide member 42 guides the light emitted from the second light source 2 toward of the display surface 5a in a particularly efficient manner. In FIG. 3, a part of the light emitted from the second light source 2 is indicated by a dashed-two dotted arrow.

The light reflection member 41 is interposed between the light guide member 42 and the first support part 31. Therefore, the light that is unnecessarily output forward from the light guide member 42 is reflected at the light reflection member 41, and re-enters the light guide member 42. Therefore, unnecessary leakage of light from the light guide member 42 is suppressed.

The illumination device 4 as described above further efficiently illuminates the NP 51 by the light emitted from each of the first light source 1 and the second light source 2 with the use of both the light reflection member 41 and the light guide member 42. Even if one of the first light source 1 and the second light source 2 is turned off due to, for example, a failure, the display surface 5a may appropriately be illuminated.

The illumination device 4 may also have such a structure that each of the first light source 1 and the second light source 2 (or each individual LED) may be turned on/off, or the light emission color or the like may be switched, manually by a driver or automatically in accordance with the brightness in the surrounding area.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An illumination device illuminating a license number plate of a vehicle, comprising:
a first light source with an optical axis directed to a display surface of the number plate;
a second light source with an optical axis extending along the display surface; and
a support member arranged around the number plate to support the first light source and the second light source.

2. The illumination device according to claim 1, wherein
each of the first light source and the second light source has a plurality of LEDs arranged side by side in a circumferential direction of the number plate,
the LED is configured to be supplied with power from the vehicle, and
the support member includes
a first support part supporting the first light source such that an optical axis of each LED included in the first light source is directed to the display surface, and
a second support part supporting the second light source such that an optical axis of each LED included in the second light source extends along the display surface.

3. The illumination device according to claim 1, wherein
the first support part has a shape of a frame arranged to be opposed to a circumferential part of the display surface,
the second support part has a tubular shape surrounding a circumferential part of the number plate,
the first light source is arranged in an annular pattern on the side of the display surface of the first support part, and
the second light source is arranged in an annular pattern on an inner circumferential surface of the second support part.

4. The illumination device according to claim 2, wherein
the first support part has a shape of a frame arranged to be opposed to a circumferential part of the display surface,
the second support part has a tubular shape surrounding a circumferential part of the number plate,
the first light source is arranged in an annular pattern on the side of the display surface of the first support part, and
the second light source is arranged in an annular pattern on an inner circumferential surface of the second support part.

5. The illumination device according to claim 3, further comprising a light guide member for guiding light emitted from the first light source or the second light source toward the display surface, wherein
the light guide member is arranged in an annular pattern to be closer to an inner circumferential part of the first support part than the first light source on the side of the display surface of the first support part.

6. The illumination device according to claim 4, further comprising a light guide member for guiding light emitted from the first light source or the second light source toward the display surface, wherein
the light guide member is arranged in an annular pattern to be closer to an inner circumferential part of the first support part than the first light source on the side of the display surface of the first support part.

7. The illumination device according to claim 1, further comprising a light reflection member or a light guide member arranged at the support member to guide light emitted from the first light source or the second light source to the side of the display surface.

8. The illumination device according to claim 2, further comprising a light reflection member or a light guide member arranged at the support member to guide light emitted from the first light source or the second light source to the side of the display surface.

9. The illumination device according to claim 3, further comprising a light reflection member or a light guide member arranged at the support member to guide light emitted from the first light source or the second light source to the side of the display surface.

10. The illumination device according to claim 4, further comprising a light reflection member or a light guide member arranged at the support member to guide light emitted from the first light source or the second light source to the side of the display surface.
